(19) United States
(12) Patent Application Publication
(10) Pub. No.: US 2024/0198284 A1
(43) Pub. Date: Jun. 20, 2024

(54) HUMIDITY CONTROL DEVICE AND METHOD OF MANUFACTURING THE SAME

(71) Applicant: AIRNOV, INC., Wilmington, New Castle, DE (US)

(72) Inventors: Sebastien Ohl, Malakoff (FR); Valere Logel, Levallois Perret (FR)

(21) Appl. No.: 18/555,352

(22) PCT Filed: Apr. 14, 2022
(86) PCT No.: PCT/EP2022/060125

§ 371 Date: Oct. 13, 2023

(30) Foreign Application Priority Data
Apr. 14, 2021 (EP) 21168342.0

(51) Int. Cl. B01D 53/26; B01D 53/28

(52) U.S. Cl. CPC B01D 53/263; B01D 53/28; B01D 2252/10; B01D 2257/80; B01D 2259/4525

(57) ABSTRACT

A humidity control device, configured to maintain the relative humidity in an enclosure within a given range by absorbing or releasing water vapor, includes an envelope and a humidity control agent arranged inside the envelope. The envelope is liquid water resistant and water vapor permeable. The humidity control agent includes a hydrated superabsorbent polymer having an adjusted moisture content selected to provide a targeted equilibrium relative humidity (ERHi) situated in the range of 45% RH to 90% RH in a sealed container.

### FIELD OF THE INVENTION

The present invention relates to a humidity control device for controlling humidity in an enclosure within a desired range. More particularly, the invention relates to a humidity control device for controlling humidity in a container, such as a medicinal, nutraceutical or pharmaceutical container. The invention also relates to a container comprising a humidity control device, and to a method of manufacturing a humidity control device.

### BACKGROUND OF THE INVENTION

Some products can lose freshness, or become damaged or even unusable, when they are subjected to environments with too much or too little humidity. For example, medicinal cannabis products, e.g. in the form of loose cannabis or pre-rolled cannabis products, can benefit from an environment with a controlled humidity. An adjusted humidity level makes it possible to preserve the fidelity of the volatile medicinal compounds of cannabis, such as cannabinoids, terpenes and flavonoids, so that the therapeutic effect of medicinal cannabis is intact, and the dose is delivered to a patient in an efficient way. In a similar way, nutraceutical or pharmaceutical products, e.g. in the form of herbs, soft gel capsules or gummies, may be better preserved in a controlled humidity environment.

To reach a desired humidity level for products, it is known to provide desiccants within a package or container in which the products are stored. However, desiccants alone do not control humidity within a desired range. To maintain humidity within a given range in an enclosure, it is known to use polymeric film pouches filled with a saturated aqueous salt solution. Such pouches are configured to provide a two-way humidity control, i.e. to both absorb and release moisture. A liquid-tight envelope is required to contain such a saturated aqueous salt solution, which is not the case of the envelope materials conventionally used for capsules or packets filled with desiccants. In addition, the relative humidity range that can be reached with a saturated aqueous salt solution is determined by the chemical nature of the salt. Then, a change in the targeted humidity range requires a change in the salt used for the saturated aqueous salt solution. It follows that several raw material supplies are needed to meet different markets, resulting in increased costs and more complex validation processes, especially for the nutraceutical and pharmaceutical sectors having specific requirements.

It is these drawbacks that the invention is intended more particularly to remedy by proposing a two-way humidity control device which can be manufactured based on conventional envelope materials used for desiccant capsules or packets, and which can be easily adapted to reach different targeted humidity levels within a broad relative humidity range, as well as a method of manufacturing a two-way humidity control device with optimal management of costs and quality risks.

### DISCLOSURE OF THE INVENTION

For this purpose, according to a first aspect, a subject of the invention is a humidity control device for maintaining the relative humidity in an enclosure within a given range by absorbing or releasing water vapor, said humidity control device comprising an envelope and a humidity control agent arranged inside the envelope, wherein the envelope is liquid water resistant and water vapor permeable, wherein the humidity control agent comprises a hydrated superabsorbent polymer such that the sum of the weight of water and the weight of dry superabsorbent polymer is higher than or equal to 90%, preferably higher than or equal to 93%, preferably higher than or equal to 97%, of the total weight of the humidity control agent, wherein the hydrated superabsorbent polymer has an adjusted moisture content corresponding to a targeted equilibrium relative humidity level (ERHi) situated in the range of 45% RH to 90% RH, preferably 50% RH to 80% RH, in a sealed container.

In the context of the invention, the targeted equilibrium relative humidity level (ERHi) is defined as the equilibrium value of the relative humidity which is reached in an empty and moisture-tightly closed glass vessel comprising therein at least one of said humidity control device so that a weight of humidity control agent per volume of air in the closed glass vessel is higher than or equal to 65 g/L. In order to determine the equilibrium value, the evolution of the relative humidity inside the glass vessel over time is measured, e.g. by means of a humidity probe such as the HC2A-S humidity probe sold by the company Rotronic, until an equilibrium value is reached. The equilibrium value of the relative humidity is obtained when a variation of the relative humidity inside the glass vessel is less than +1% RH over 6 consecutive hours. Within the frame of the invention, the targeted equilibrium relative humidity level (ERHi) is determined at ambient temperature, typically 20° C.±2° C.

Within the meaning of the invention, the moisture content (also abbreviated as “MC”) of a humidity control agent relates to the amount of water (usually expressed as weight) absorbed in the humidity control agent relative to the dry weight of said humidity control agent. Herein, the moisture content is usually expressed in percent by weight.

Within the meaning of the invention, the terms “absorb”, “absorbing” or “absorption”, when referring to a given material, with respect to water, are used to encompass all chemical and physical phenomena by which water may be retained by said material. In particular, this includes bulk phenomena, generally referred to as “absorption”, where water molecules enter the material; or surface phenomena, generally referred to as “adsorption”, where water molecules attach to the surface of the material.

In the context of the invention, a moisture-tightly closed glass vessel has a Water Vapor Transmission Rate (WVTR) of less than 1 mg per 24 hours and per gram of humidity control agent present in the closed glass vessel, measured in an environment at 40° C. with a relative humidity of 75% RH.

In practice, to evaluate the targeted equilibrium relative humidity level (ERHi), i.e. the relative humidity level at which regulation is intended to take place with said humidity control device, an appropriate number of humidity control devices is placed in a moisture-tightly closed glass vessel, where the appropriate number of humidity control devices is determined according to the volume of the closed glass vessel so as to reach the minimum quantity of humidity control agent as defined above, i.e. at least 65 g of hydrated superabsorbent polymer per liter of air in the closed glass vessel.

For example, for a humidity control capsule containing 1 g of humidity control agent, the targeted equilibrium relative humidity level (ERHi) may be evaluated by placing at least 20 capsules in a moisture-tightly closed glass vessel having a volume of 300 mL, where 20 capsules corresponds to 66.7 g of humidity control agent per liter of air in the closed glass vessel; for a humidity control bag containing 500 g of humidity control agent, the targeted equilibrium relative humidity level (ERHi) may be evaluated by placing at least one bag in a moisture-tightly closed glass vessel having a volume of 7.5 L, where one bag corresponds to 66.7 g of humidity control agent per liter of air in the closed glass vessel.

Advantageously, the hydrated superabsorbent polymer of a humidity control device according to the invention can absorb moisture from the surrounding atmosphere, when the relative humidity is higher than the targeted equilibrium relative humidity level (ERHi), and release moisture to the surrounding atmosphere, when the relative humidity is lower than the targeted equilibrium relative humidity level (ERHi). Thus, the humidity control device is a two-way humidity control device.

For a humidity control device according to the invention, the sum of the weight of water and the weight of dry superabsorbent polymer is higher than or equal to 90%, preferably higher than or equal to 93%, preferably higher than or equal to 97%, of the total weight of the humidity control agent, which means that the humidity control agent of a humidity control device according to the invention comprises a hydrated superabsorbent polymer as its main component. Other components in the composition of the humidity control agent may include additives, added only in small amounts of less than 10 wt %, where the wt %-number provides the % of weight of the additives over the total weight of the humidity control agent. According to one embodiment, the hydrated superabsorbent polymer may be the sole component of the humidity control agent.

The inventors have found that the properties of superabsorbent polymers, in terms of water absorption and release, can be used to form a humidity control agent comprising a superabsorbent polymer and water as the main components, i.e. such that the sum of the weight of water and the weight of dry superabsorbent polymer is higher than or equal to 90%, preferably higher than or equal to 93%, preferably higher than or equal to 97%, of the total weight of the humidity control agent. An amount of liquid water adjusted according to the targeted equilibrium relative humidity (ERHi) is added to a substantially dry superabsorbent polymer. Preferably, the resulting material is allowed to age and equilibrate for a period of at least 15 days at 20° C.±5° C., prior to being used as a humidity equilibrant. The weight of liquid water added is between 10% and 150% of the dry weight of the superabsorbent polymer, well below the total water retention capacity of the superabsorbent polymer.

Small amounts of additive materials may be added to the composition of the humidity control agent to provide additional properties thereto. Such additive materials may be, for example, humidity absorbers, oxygen scavengers, odor absorbers, emitters of volatile olfactory organic compounds, flavors, antibacterial materials, antifungal materials, etc. The weight proportion of the additive materials is limited to a maximum of 10% of the total weight of the humidity control agent, and, in the range of 50% RH to 80% RH, the equilibrium relative humidity level (ERHi) reached by a humidity control device for which the composition of the humidity control agent comprises additive materials is substantially equal to the equilibrium relative humidity level obtained from a humidity control device only differing from the latter in that the composition of the humidity control agent does not comprise the additive materials. According to one feature, the equilibrium relative humidity level (ERHi) obtained from a humidity control device for which the composition of the humidity control agent comprises additive materials is within a range of +7% RH, preferably +5% RH, around the equilibrium relative humidity level obtained from a humidity control device for which the composition of the humidity control agent only comprises the same superabsorbent polymer and the same amount of water.

The use of a hydrated superabsorbent polymer (or SAP) as a humidity control agent in a humidity control device has several advantages. First, a superabsorbent polymer exhibits a high rate of water absorption (or water retention) and remains in a solid or gel form even with a high moisture content. Thus, the envelope of a humidity control device according to the invention does not have to be liquid tight, which makes it possible to use the same envelope materials as those conventionally used for capsules or packets filled with desiccants.

Another advantage is that the moisture content of a hydrated superabsorbent polymer can be easily adjusted to reach different values of the targeted equilibrium relative humidity level (ERHi) within the broad relative humidity range of 45% RH to 90% RH. Thus, starting from one substantially dry superabsorbent polymer, it is possible to obtain humidity control devices with different values of the targeted equilibrium relative humidity level (ERHi), simply by modulating the hydration rate of the superabsorbent polymer, i.e. the quantity of water added thereto.

For example, a first type of pharmaceuticals or botanicals may be most stable and best consumed at a first humidity level of 60% RH, whereas a second type of pharmaceuticals or botanicals may be most stable and best consumed at a second humidity level of 70% RH. Thanks to the invention, the same superabsorbent polymer raw material and the same manufacturing line can be used to produce two types of humidity control devices intended for the two different types of products, i.e. a first type of humidity control devices for regulation at the first targeted equilibrium relative humidity level (ERH₁) of 60% RH, with a first moisture content (MC₁) of the superabsorbent polymer, and a second type of humidity control devices for regulation at a second targeted equilibrium relative humidity level (ERH₂) of 70% RH, with a second moisture content (MC₂) of the superabsorbent polymer.

According to one feature, the humidity control agent is enclosed inside the envelope. In other words, the envelope enwraps the humidity control agent on all sides.

The targeted equilibrium relative humidity level (ERHi) according to the invention depends on a combination of the moisture content of the hydrated superabsorbent polymer and the water vapor transfer capacity of the envelope. Conventionally, the water vapor transfer capacity of the envelope is defined as the amount of moisture transferred, into or out of the envelope, over a defined relative humidity range.

According to the invention, the envelope of the humidity control device is liquid water resistant and water vapor permeable. Within the frame of the invention, a liquid water resistant envelope is an envelope which, in any orientation of the envelope, has a resistance to the passage of liquid water sufficient to allow for at least ⅔ of the inner volume of the envelope to be filled with liquid water without any liquid water leaking to the outer surface of the envelope during the filling time.

In practice, materials having a Frazier air permeance of less than 30 cm³·cm⁻²·s⁻¹, preferably less than 20 cm³·cm⁻²·s⁻¹, preferably less than 15 cm³·cm⁻²·s⁻¹, measured using the Frazier test method in accordance with standard test method ASTM D737, are appropriate to form a water resistant envelope as defined above. Such materials withstand the passage of liquid water for a time sufficient to allow a superabsorbent polymer placed in the envelope to absorb liquid water added thereto. In other words, the liquid water and the superabsorbent polymer can be introduced in the envelope such that the time required for the water to be absorbed by the superabsorbent polymer is lower than the time required for the water to leak out through the material of the envelope.

According to one feature, the liquid water resistant envelope is either made entirely of a gas-permeable material having a Frazier air permeance of less than 30 cm³·cm⁻²·s⁻¹, preferably less than 20 cm³·cm⁻²·s⁻¹, preferably less than 15 cm³·cm⁻²·s⁻¹, or made of at least one part of a gas-impermeable material and at least one part of a gas-permeable material having a Frazier air permeance of less than 30 cm³·cm⁻²·s⁻¹, preferably less than 20 cm³·cm⁻²·s⁻¹, preferably less than 15 cm³·cm⁻²·s⁻¹.

According to the invention, the material of the envelope is devoid of through holes having a size causing leakage of liquid water through the envelope.

In particular, the liquid water resistant envelope may comprise: macroporous materials, such as non-woven fabrics or perforated polymer films, for which the Frazier test method yields Frazier air permeance values higher than zero and less than 30 cm³·cm⁻²·s⁻¹; microporous materials, such as gas-permeable cardboards, for which Frazier air permeance values are substantially equal to zero; and/or homogenous gas-impermeable films; the thickness, exchange surface and water vapor transmission rate of the constitutive material(s) of the envelope being so selected as to achieve a water vapor transfer capacity of the envelope higher than or equal to 20 mg per 24 hours, preferably higher than or equal to 50 mg per 24 hours, in an environment at 30° C. with a relative humidity of 65% RH.

In practice, the water vapor transfer capacity of an envelope may be measured by any appropriate method known in the art, e.g. by filling the envelope with a desiccant material, such as a molecular sieve, and rapidly sealing the filled envelope in an environment with a low relative humidity of less than 50% RH. Of course, other desiccant materials may also be used in combination with or in place of molecular sieve, e.g. silica gel or anhydrous calcium chloride CaCl₂). The original weight of the filled envelope is measured. The filled envelope is then placed for 24 hours in a climatic chamber set at 30° C., 65% RH. After 24 hours, the weight of the filled envelope is measured again and the water vapor transfer capacity of the envelope per 24 hours is calculated from the difference between the two measurements of the weight of the filled envelope.

According to one feature, the selected superabsorbent polymer for the humidity control agent is a superabsorbent polymer which absorbs more than 500 mg of water per gram of dry superabsorbent polymer, when the equilibrium relative humidity is increased from ERH1=50% RH to ERH2=80% RH. This amount of added water is defined as the buffering capacity of the superabsorbent polymer, which is an intrinsic property of the superabsorbent polymer. A higher buffering capacity means that less variation in the equilibrium relative humidity will occur when the humidity control device is introduced in a packaging containing moisture sensitive products.

According to one feature, the moisture content of the hydrated superabsorbent polymer corresponds to a targeted equilibrium relative humidity level (ERHi) in an enclosure comprising said humidity control device, and the humidity control device is configured to maintain the relative humidity in the enclosure within a range of +10% RH or less around the targeted equilibrium relative humidity level (ERHi).

According to one feature, the hydrated superabsorbent polymer, with said adjusted moisture content corresponding to the targeted equilibrium relative humidity level (ERHi) situated in the range of 50% RH to 80% RH, is capable of absorbing or releasing at least 60 mg, preferably at least 100 mg, of water vapor per gram of dry superabsorbent polymer while still maintaining the relative humidity in an enclosure within a range of +10% RH around the targeted equilibrium relative humidity level (ERHi). Such a buffering capacity of the hydrated superabsorbent polymer ensures that the equilibrium relative humidity level in an enclosure is maintained within a range of +10% RH or less around the targeted equilibrium relative humidity level (ERHi), even in the presence of instability factors such as a certain permeability of the enclosure to moisture and/or liquids, or the influence of the moisture content of other products present in the enclosure, typically sensitive products to be stored at said targeted equilibrium relative humidity level. It is understood that, within the meaning of the invention, a dry superabsorbent polymer is a superabsorbent polymer having a moisture content of 0%.

According to one feature, the superabsorbent polymer has a water retention capacity greater than or equal to 30 times its weight in demineralized water, preferably greater than or equal to 50 times its weight in demineralized water, more preferably greater than or equal to 100 times its weight in demineralized water. In one embodiment, the superabsorbent polymer may be in a powder or granulate form, whether agglomerated or not. The structure of a superabsorbent polymer is typically based on a three-dimensional network similar to a multitude of small cavities each having the capacity to deform and absorb water, thus giving the superabsorbent polymer the capacity of absorbing very large quantities of water and the capacity of swelling.

According to one embodiment, the superabsorbent polymer comprises a natural polymer, e.g. it may be an alginate-based superabsorbent polymer.

According to one embodiment, the superabsorbent polymer is based on a cross-linked synthetic polymer or copolymer. In one embodiment, the monomers used for the preparation of the superabsorbent polymer, which are preferably partially or totally salified, may be chosen from: acrylamide and/or acrylic acid; and/or ATBS (acrylamide tertiary butyl sulfonic acid); and/or NVP (N-Vinylpyrrolidone); and/or acryloylmorpholine; and/or itaconic acid. According to one feature, the superabsorbent polymer is a cross-linked polymer comprising anionic charges carried by partially or totally salified acrylic acid monomers, such as a cross-linked sodium polyacrylate; a cross-linked potassium polyacrylate; a cross-linked copolymer acrylamide/potassium acrylate.

Examples of commercial superabsorbent polymers that may be used in the context of the invention include, without limitation: the products sold by the company Aprotek under the trademark APROPACK, based on sodium polyacrylate, in particular APROPACK G300; the products sold by the company Evonik Industries under the trademark FAVOR PAC, based on sodium polyacrylate, in particular FAVOR PAC 593 or FAVOR PAC 610. Advantageously, the superabsorbent polymer is suitable for food contact applications.

According to one feature, the hydrated superabsorbent polymer has an adjusted moisture content of between 10% and 150%, preferably between 10% and 120%, the moisture content of the hydrated superabsorbent polymer being the ratio of the weight of water to the weight of dry superabsorbent polymer.

According to one feature, an expansion factor of the humidity control agent arranged in the envelope, defined as the ratio of the volume of the humidity control agent to the volume of the dry superabsorbent polymer contained in the humidity control agent is less than 4, preferably less than 3, preferably less than 2. It is noted that, starting from a hydrated superabsorbent polymer, the volume of the corresponding dry superabsorbent polymer can be determined by placing the hydrated superabsorbent polymer in an oven at a temperature of 110° C.±5° C. for 24 hours and measuring the volume of the dried superabsorbent polymer thus obtained.

As explained above, adding liquid water to a superabsorbent polymer results in an increase in the volume of the superabsorbent polymer. The inventors have found that humidity equilibration properties in the range of 45% RH to 90% RH, preferably 50% RH to 80% RH, are achieved when the volume increase of the superabsorbent polymer is limited to a factor 4, preferably to a factor 3, preferably to a factor 2.

Tests have been carried out, using the superabsorbent polymer FAVOR PAC 593 sold by the company Evonik Industries (particle size distribution: 45 μm-600 μm; bulk density: 0.48-0.6 g/cm³). A volume of 20 cm³ of the substantially dry superabsorbent polymer FAVOR PAC 593 was introduced in each of a first glass container and a second glass container. An adjusted quantity of liquid water was then added to the superabsorbent polymer in each of the first and second glass containers in such a way as to obtain, respectively, a first hydrated superabsorbent polymer regulating at 70% RH in the first glass container and a second hydrated superabsorbent polymer regulating at 80% RH in the second glass container. In each glass container, the mixture comprising the superabsorbent polymer and the liquid water was left for about 30 minutes at room temperature. The height of the hydrated superabsorbent polymer in each glass container was then measured, and the final volume of the hydrated superabsorbent polymer was calculated based on the dimensions of the glass container. The expansion factor was also calculated, defined as the ratio of the final volume of the hydrated superabsorbent polymer to the initial volume of the substantially dry superabsorbent polymer.

The results are given in Table 1 below.

TABLE 1

| | Volume of | Volume of | Total | Final volume | |
|---|---|---|---|---|---|
| Targeted | dry SAP | liquid water | volume | of hydrated | Expansion |
| ERH | (cm³) | added (cm³) | (cm³) | SAP (cm³) | Factor |
| 70% RH | 20 | 7 | 27 | 23 | 1.15 |
| 80% RH | 20 | 11 | 31 | 27 | 1.35 |

According to one feature, a ratio of the inner volume of the envelope to the volume of the dry superabsorbent polymer contained in the humidity control agent is less than 4, preferably less than 3, preferably less than 2. With such a volume of the envelope, the volume expansion of the humidity control agent is limited by the envelope, and it is thus possible to limit the moisture content of the humidity control agent and the resulting equilibrium relative humidity (ERHi) to a maximum value. In other words, the targeted equilibrium relative humidity level (ERHi) may be obtained by selecting an appropriate inner volume of the envelope.

According to one feature, the time to reach the targeted equilibrium relative humidity level (ERHi) within +2% RH, in an enclosure comprising the humidity control device, is less than 24 hours, preferably less than 6 hours, more preferably less than 2 hours. Such a kinetics of humidity control, which depends on the quantity of hydrated superabsorbent polymer and the volume and permeability of the enclosure, ensures that the equilibrium relative humidity level is reached rapidly in an enclosure.

According to one embodiment, the humidity control device is in the form of a humidity control capsule or canister, the liquid water resistant envelope comprising a gas-impermeable body configured to receive the hydrated superabsorbent polymer and at least one gas-permeable cover configured to close the body so that the hydrated superabsorbent polymer is retained inside the envelope. By way of non-limiting examples, a humidity control capsule may comprise a thermoplastic tubular body filled with the hydrated superabsorbent polymer and closed by a gas-permeable cardboard for which the Frazier air permeance is substantially zero; a humidity control canister may comprise a thermoplastic tubular body filled with the hydrated superabsorbent polymer and closed by a thermoplastic cap comprising at least one perforation covered by a gas permeable membrane having a Frazier air permeance of less than 30 cm³·cm⁻²·s⁻¹, preferably less than 20 cm³·cm⁻²·s⁻¹, preferably less than 15 cm³·cm⁻²·s⁻¹.

According to another embodiment, the humidity control device is in the form of a humidity control closure intended to close an opening of a container, the liquid water resistant envelope comprising walls of the closure defining a gas-impermeable body configured to receive the hydrated superabsorbent polymer and at least one gas-permeable cover configured to close the body so that the hydrated superabsorbent polymer is retained inside the envelope. By way of a non-limiting example, a humidity control closure according to the invention may comprise a thermoplastic tubular body filled with the hydrated superabsorbent polymer and closed by a gas-permeable cardboard for which the Frazier air permeance is substantially zero.

According to another embodiment, the humidity control device is in the form of a humidity control bag or packet (or sachet), the liquid water resistant envelope comprising a gas permeable membrane configured to enwrap the hydrated superabsorbent polymer, such as a non-woven fabric or a perforated polymer film having a Frazier air permeance of less than 30 cm³·cm⁻²·s⁻¹, preferably less than 20 cm³·cm⁻²·s⁻¹, preferably less than 15 cm³ cm⁻²·s⁻¹. Examples of polymer fabrics that may be used for the envelope of a humidity control bag or packet according to the invention include non-woven fabrics based on polyethylene or polypropylene fibers. In particular, suitable materials include the products sold by the company DuPont under the trademark TYVEK, which are spun-bonded non-woven fabrics comprising polyethylene fibers, in particular based on high-density polyethylene (HDPE) fibers; the products sold by the company Unisel Co., Ltd under the trademark MELFIT, which are spun-bonded non-woven fabrics comprising polyethylene terephthalate (PET) fibers and polypropylene (PP) fibers. Examples of perforated polymer films that may be used for the envelope of a humidity control bag or packet according to the invention include perforated films of polyethylene or polypropylene.

According to a second aspect, another subject of the invention, which may be considered independently from the features described above, and in particular independently from the feature that the envelope is liquid water resistant, is a humidity control device for maintaining the relative humidity in an enclosure within a given range by absorbing or releasing water vapor, said humidity control device comprising a water vapor permeable envelope and a humidity control agent arranged inside the envelope, wherein the humidity control agent comprises a hydrated superabsorbent polymer such that the sum of the weight of water and the weight of dry superabsorbent polymer is higher than or equal to 90%, preferably higher than or equal to 93%, preferably higher than or equal to 97%, of the total weight of the humidity control agent, wherein the hydrated superabsorbent polymer has an adjusted moisture content corresponding to a targeted equilibrium relative humidity level (ERHi) situated in the range of 45% RH to 90% RH, preferably 50% RH to 80% RH, in a sealed container, wherein the superabsorbent polymer in the composition of the humidity control agent is a superabsorbent polymer which absorbs more than 500 mg of water per gram of dry superabsorbent polymer, when the equilibrium relative humidity is increased from ERH1=50% RH to ERH2=80% RH. It is understood that all the other features described previously with respect to the humidity control device according to the first aspect of the invention, may be applied to the humidity control device according to the second aspect of the invention. In some embodiments of this second aspect, the envelope of the humidity control device may have at least one wall which is liquid permeable.

Another subject of the invention is a closable container comprising at least one sensitive product, such as a medicinal, nutraceutical or pharmaceutical product, and at least one humidity control device, wherein, in the closed state of the container containing the at least one sensitive product, the at least one humidity control device is configured to exchange water vapor with the inner volume of the container and the at least one sensitive product so as to maintain a given equilibrium relative humidity level (ERHg), wherein the at least one humidity control device comprises an envelope and a humidity control agent arranged inside the envelope, wherein the envelope is liquid water resistant and water vapor permeable, wherein the humidity control agent comprises a hydrated superabsorbent polymer such that the sum of the weight of water and the weight of dry superabsorbent polymer is higher than or equal to 90%, preferably higher than or equal to 93%, preferably higher than or equal to 97%, of the total weight of the humidity control agent, wherein the hydrated superabsorbent polymer has an adjusted moisture content so selected as to provide a given equilibrium relative humidity level (ERHg) in the closed container situated in the range of 45% RH to 90% RH, preferably 50% RH to 80% RH, more preferably 50% RH to 70% RH. By way of example, in the context of the invention, the at least one humidity control device configured to exchange water vapor with the inner volume of the container may be dropped in the inner volume of the container, e.g. in the form of a capsule, a canister, a bag or a packet; or else it may be part of a closure closing the container.

In the closed state of the container comprising the at least one sensitive product and the at least one humidity control device, the given equilibrium relative humidity level (ERHg) is maintained in the container after a time sufficient for the system to reach equilibrium. In other words, in a container according to the invention having reached equilibrium, the water activity aw of the at least one humidity control device and the water activity aw of the at least one sensitive product are substantially equal to each other, with a value of between 0.45 and 0.9, preferably between 0.5 and 0.8, more preferably between 0.5 and 0.7, where the water activity aw is defined as the ratio between the partial vapor pressure of water in the humidity control device, respectively in the sensitive product, and the vapor pressure of pure water at the same temperature. In the context of the invention, two values of water activity are considered equal when the absolute value of their difference is less than or equal to 0.1.

In practice, the water activity aw of a humidity control device or a sensitive product is measured in a way similar to the targeted equilibrium relative humidity level (ERHi) as described above, i.e. by removing said humidity control device or sensitive product from the container according to the invention, and rapidly placing said humidity control device or sensitive product in an empty and moisture-tightly closed glass vessel. In order to determine the water activity aw, the evolution of the relative humidity inside the glass vessel over time is measured, e.g. by means of a humidity probe such as the HC2A-S humidity probe sold by the company Rotronic, until an equilibrium value is reached, which corresponds to a variation of the relative humidity inside the glass vessel of less than +1% RH over 6 consecutive hours. Within the frame of the invention, the water activity aw of a humidity control device or a sensitive product is determined at ambient temperature, typically 20° C.±2° C. The equilibrium relative humidity percentage reached in the moisture-tightly closed glass vessel is equal to the water activity aw of said humidity control device or sensitive product multiplied by 102.

It is understood that a container falls within the scope of the invention when it comprises at least one sensitive product and at least one humidity control device as described above, configured to maintain the relative humidity in the container within a given range around a given equilibrium relative humidity level situated in the range of between of 45% RH and 90% RH, preferably between 50% RH and 80% RH, more preferably between 50% RH and 70% RH, regardless of whether the container has reached equilibrium or not.

In one embodiment of a container according to the invention, the hydrated superabsorbent polymer, with said adjusted moisture content, is capable of absorbing or releasing at least 60 mg, preferably at least 100 mg, of water vapor per gram of dry superabsorbent polymer while maintaining the relative humidity in the closed container within a range of +10% RH around the given equilibrium relative humidity level (ERHg) situated in the range of 50% RH to 80% RH. Advantageously, such a buffering capacity of the hydrated superabsorbent polymer ensures that the equilibrium relative humidity level in the closed container is maintained within a range of +10% RH or less, even in the presence of instability factors such as a certain permeability of the container to moisture and/or liquids, or the influence of the moisture content of the at least one sensitive product present in the container.

Another subject of the invention is a use of a humidity control device as described above for maintaining the relative humidity between 45% RH and 90% RH, preferably between 50% RH and 80% RH, in a container comprising in its inner volume at least one sensitive product, such as a medicinal, nutraceutical or pharmaceutical product, wherein, in the closed state of the container containing the at least one sensitive product, the humidity control device is configured to exchange water vapor with the inner volume of the container and the at least one sensitive product.

In particular, one embodiment relates to the use of a humidity control device as described above for maintaining the relative humidity within a restricted range of ±10% RH within the broader relative humidity range of between 45% RH and 90% RH, preferably between 50% RH and 80% RH, in a container comprising in its inner volume at least one sensitive product, such as a medicinal, nutraceutical or pharmaceutical product, wherein, in the closed state of the container containing the at least one sensitive product, the humidity control device is configured to exchange water vapor with the inner volume of the container and the at least one sensitive product. This may be achieved by selecting a hydrated superabsorbent polymer with an appropriate buffering capacity, e.g. capable of absorbing or releasing at least 60 mg, preferably at least 100 mg, of water vapor per gram of dry superabsorbent polymer while maintaining the equilibrium relative humidity in the closed container within a range of ±10% RH or less.

A further subject of the invention is a use of a humidity control device as described above for maintaining the relative humidity between 45% RH and 65% RH, preferably between 50% RH and 65% RH, in a container comprising in its inner volume at least one cannabis product, wherein, in the closed state of the container containing the at least one cannabis product, the humidity control device is configured to exchange water vapor with the inner volume of the container and the at least one cannabis product.

A further subject of the invention is a use of a humidity control device as described above for maintaining the relative humidity between 45% RH and 70% RH, preferably between 60% RH and 70% RH, in a container comprising in its inner volume at least one soft gel capsule or gummy dosage form, wherein, in the closed state of the container containing the at least one soft gel capsule or gummy dosage form, the humidity control device is configured to exchange water vapor with the inner volume of the container and the at least one soft gel capsule or gummy dosage form.

Another subject of the invention is a method of manufacturing a humidity control device as described above, said method comprising steps of:
a) providing the envelope;
b) introducing, in at least one part of the envelope, a given weight of the superabsorbent polymer having a known moisture content lower than or equal to the moisture content corresponding to the targeted equilibrium relative humidity level (ERHi);
c) if the known moisture content of the superabsorbent polymer is lower than the moisture content corresponding to the targeted equilibrium relative humidity level (ERHi) of the humidity control device, introducing a given weight of water in the at least one part of the envelope;
d) optionally, repeating steps b) and c) until a desired weight of hydrated superabsorbent polymer, having the moisture content corresponding to the targeted equilibrium relative humidity level (ERHi), is received in the at least one part of the envelope.

In the above method, steps b) and c) may be performed in any sequence order, or in parallel.

In the above method, the envelope may be provided in step a) in an open configuration. Then, the method may comprise a further step of closing the envelope once a desired weight of hydrated superabsorbent polymer, having the moisture content corresponding to the targeted equilibrium relative humidity level (ERHi), is received in the at least one part of the open envelope, so that the hydrated superabsorbent polymer is retained inside the envelope.

According to one feature of the above method of manufacturing a humidity control device, the hydrated superabsorbent polymer is in a powder form, a granulate form and/or a solid agglomerated form. Preferably, the superabsorbent polymer is in a powder form, a granulate form and/or a solid agglomerated form in its initial state, where its moisture content is lower than the moisture content corresponding to the targeted equilibrium relative humidity level (ERHi), and in its final hydrated state, where its moisture content corresponds to the targeted equilibrium relative humidity level (ERHi).

In a first embodiment of the manufacturing method, the superabsorbent polymer is introduced in the at least one part of the envelope in a state where its moisture content is strictly lower than the moisture content corresponding to the targeted equilibrium relative humidity level (ERHi), and preferably in a substantially dry state. The use of a substantially dry superabsorbent polymer when filling the envelope facilitates dosing and improves dosing accuracy, especially when the dose of superabsorbent polymer to be introduced in the envelope is prepared using a volumetric metering device, as this ensures good control of the particle size and therefore the bulk density of the superabsorbent polymer.

The manufacturing method according to the first embodiment is particularly advantageous in that it is easier to introduce the superabsorbent polymer in the envelope in a state where its moisture content is relatively low, because the viscosity or stickiness of the superabsorbent polymer may increase with increasing moisture content, possibly interfering with proper handling on a manufacturing line. For example, the superabsorbent polymers APROPACK G300, FAVOR PAC 593 or FAVOR PAC 610, may be introduced in the envelope in their commercially available state, which is a substantially dry state of the superabsorbent polymer with a moisture content of less than or equal to 8%, corresponding to a powder or granulate form with good flowability.

In the manufacturing method according to the first embodiment, the adjusted moisture content corresponding to the targeted equilibrium relative humidity level (ERHi) is reached by providing water to the humidity control agent directly in situ in the final envelope of the humidity control device, the superabsorbent polymer having an initial moisture content strictly lower than said adjusted moisture content and being configured to absorb the water added thereto. Such a method of manufacturing a humidity control device in which a hydrated superabsorbent polymer is prepared in situ in the envelope of the humidity control device has several advantages. First, compared to methods where a quantity of hydrated superabsorbent polymer is prepared beforehand, as an intermediate product having said adjusted moisture content corresponding to the targeted equilibrium relative humidity level (ERHi), and is dispensed successively in several envelopes of humidity control devices, the above method eliminates a preliminary process step and avoids having to store and dispense the intermediate product. The above method also eliminates the need to define suitable packaging and storage conditions to avoid any drift in the moisture content of the intermediate product and therefore in the corresponding targeted equilibrium relative humidity level (ERHi). This results in reduced quality risks and in reduced costs.

Another advantage of the manufacturing method according to the first embodiment is that the quantity of water to be added into the envelope of the humidity control device can be adjusted precisely according to the initial moisture content of the superabsorbent polymer introduced in the envelope. In particular, the initial moisture content of the superabsorbent polymer to be introduced in successive envelopes can be measured for each new batch of superabsorbent polymer used on a manufacturing line, or even continuously, whereas the quantity of water to be added in one envelope is adjusted, e.g. automatically, according to the initial moisture content measured for the superabsorbent polymer introduced in said envelope. Due to the relatively small volume of the envelope of the humidity control device, the above method in which the hydrated superabsorbent polymer is prepared in situ in the envelope also eliminates the need for a mixing or homogenization operation to obtain the hydrated superabsorbent polymer. Because of the relatively low amounts of water and superabsorbent polymer introduced in each envelope, the water tends to be well distributed relative to the superabsorbent polymer, even in the absence of mixing.

According to one feature of the manufacturing method according to the first embodiment, the water is introduced in the at least one part of the envelope in a liquid state, which makes it possible to easily and precisely control the amount of water added to the superabsorbent polymer, and thus the moisture content of the final hydrated superabsorbent polymer.

According to one feature of the manufacturing method according to the first embodiment, the given weights of water and superabsorbent polymer are introduced in the at least one part of the envelope at a rate such that the time required for the water to be absorbed by the superabsorbent polymer is lower than the time required for the water to leak out of the at least one part of the envelope.

According to one implementation of the manufacturing method according to the first embodiment, a dose of the superabsorbent polymer is introduced in the at least one part of the envelope before a dose of water in a liquid state is introduced in the at least one part of the envelope. This may be implemented, e.g., for the manufacturing of humidity control bags or packets, where the superabsorbent polymer dose may advantageously be introduced in a substantially dry state in the open envelope formed by a partially welded tube of non-woven material, and the water dose may then be added thereto. In this way, leaks of liquid water through the porous material of the open envelope of the bag or packet can be avoided because the water is absorbed by the superabsorbent polymer more rapidly than the time required for the water to leak.

According to another implementation of the manufacturing method according to the first embodiment, a dose of water in a liquid state is introduced in the at least one part of the envelope before a dose of the superabsorbent polymer is introduced in the at least one part of the envelope. This may be implemented, e.g., for the manufacturing of humidity control capsules, canisters or stoppers, where the water dose may advantageously be introduced in the thermoplastic body forming a part of the envelope, and the superabsorbent polymer dose may then be added thereto before closing the thermoplastic body with a gas-permeable cover. In this way, uncontrolled loss of water can be avoided, which may happen in case of injection of water on a layer of superabsorbent polymer already present in a small body. In addition, the volume expansion of the superabsorbent polymer can be better controlled so as not to interfere with the placement of the gas permeable cover.

In a second embodiment of the manufacturing method, the superabsorbent polymer is introduced in the at least one part of the envelope directly in a hydrated state where its moisture content corresponds to the targeted equilibrium relative humidity level (ERHi) of the humidity control device. In this case, no addition of water is needed in the envelope, and the desired weight of hydrated superabsorbent polymer can be directly inserted in the envelope.

According to one feature, a plurality of humidity control devices, which can be obtained by the manufacturing method described above, are grouped together in a liquid and moisture-tight storage package. The number of humidity control devices grouped together in the storage package is advantageously higher than 50, preferably higher than 100. Storing a plurality of humidity control devices inside the same moisture-tight storage package allows moisture to equilibrate between all the humidity control devices received in the storage package, so that variations in the moisture content from one humidity control device to another are smoothed. In this way, the tolerance interval for the moisture content and the targeted equilibrium relative humidity level (ERHi) of each humidity control device is reduced compared to that obtained when each humidity control device is packaged separately.

In one embodiment, the storage package may be a heat-sealable package comprising a multilayer material with at least one barrier layer providing gas barrier properties, e.g. an aluminum layer, and at least one heat-sealable layer, e.g. a polyethylene layer. Advantageously, the material of the storage package has a Water Vapor Transmission Rate (WVTR) of less than 0.1 g/m²-day (38° C., 90% RH) evaluated according to ASTM E398.

### BRIEF DESCRIPTION OF THE DRAWINGS

Features and advantages of the invention will become apparent from the following description of embodiments of a humidity control device according to the invention, this description being given merely by way of example and with reference to the appended drawings in which:

FIG. 1 is a perspective view of a humidity control capsule according to a first embodiment of the invention;

FIG. 2 is a cross section according to plane II of FIG. 1;

FIG. 3 is a cross section of a closable bottle containing a plurality of nutraceutical gummies and the humidity control capsule of FIG. 1 for maintaining the relative humidity in the bottle within a given range around a targeted equilibrium relative humidity level;

FIG. 4 is a graph of the evolution of the relative humidity level over time of a humidity control capsule as shown in FIG. 1, with a moisture content of the hydrated superabsorbent polymer of the capsule corresponding to a first targeted equilibrium relative humidity level of the order of 60% RH, where the evolution of the relative humidity level over time has been measured by placing twenty humidity control capsules, each containing 1.5 g of hydrated superabsorbent polymer, in an empty and moisture-tightly closed glass vessel having a volume of 300 mL;

FIG. 5 is a graph similar to FIG. 4 of the evolution of the relative humidity level over time of a humidity control capsule as shown in FIG. 1, with a moisture content of the hydrated superabsorbent polymer of the capsule corresponding to a second targeted equilibrium relative humidity level of the order of 70% RH, where the evolution of the relative humidity level over time has been measured by placing twenty humidity control capsules, each containing 1.5 g of hydrated superabsorbent polymer, in an empty and moisture-tightly closed glass vessel having a volume of 300 mL;

FIG. 6 is a schematic top view of a manufacturing line for producing humidity control capsules similar to that of FIG. 1 and for packaging them into a liquid and moisture-tight storage package;

FIG. 7 is a perspective view of a humidity control bag according to a second embodiment of the invention;

FIG. 8 is a cross section according to plane VIII of FIG. 7;

FIG. 9 is a perspective view of a closable pouch containing a plurality of cannabis flowers and the humidity control bag of FIG. 7 for maintaining the relative humidity in the pouch within a given range around a targeted equilibrium relative humidity level;

FIG. 10 is a graph of the evolution of the relative humidity level over time of a humidity control bag as shown in FIG. 7, with a moisture content of the hydrated superabsorbent polymer of the bag corresponding to a targeted equilibrium relative humidity level of the order of 60% RH, where the evolution of the relative humidity level over time has been measured by placing one humidity control bag, containing 105 g of hydrated superabsorbent polymer, in an empty and moisture-tightly closed glass vessel having a volume of 1.5 L;

FIG. 11 is a schematic side view of a manufacturing line for producing humidity control bags similar to that of FIG. 7 and for packaging them into a liquid and moisture-tight storage package;

FIG. 12 is a perspective view of a humidity control canister according to a third embodiment of the invention;

FIG. 13 is a cross section according to plane XIII of FIG. 12;

FIG. 14 is a perspective view of a humidity control closure according to a fourth embodiment of the invention; and

FIG. 15 is a cross section according to plane XV of FIG. 14 of the closure sealingly closing a pharmaceutical container.

### ILLUSTRATIVE EMBODIMENTS OF THE INVENTION

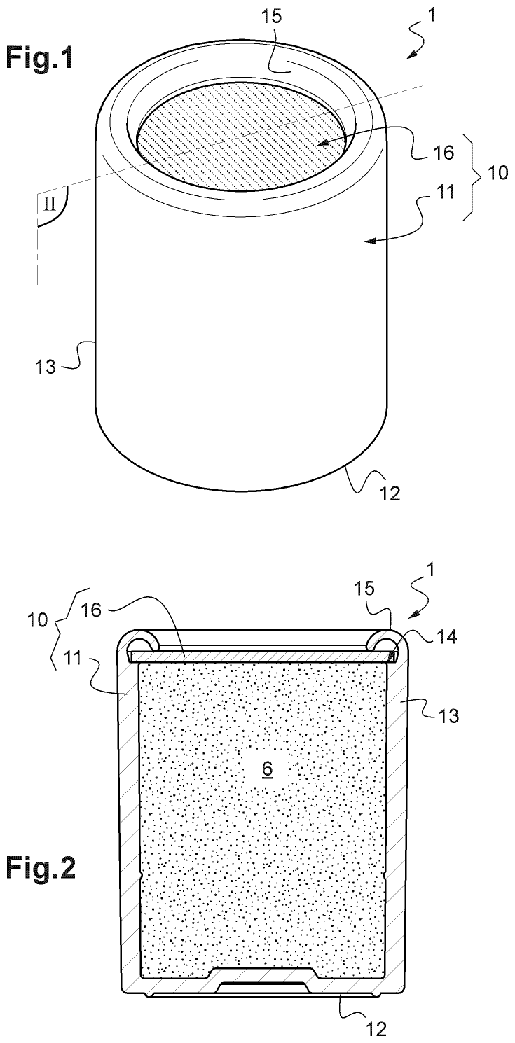

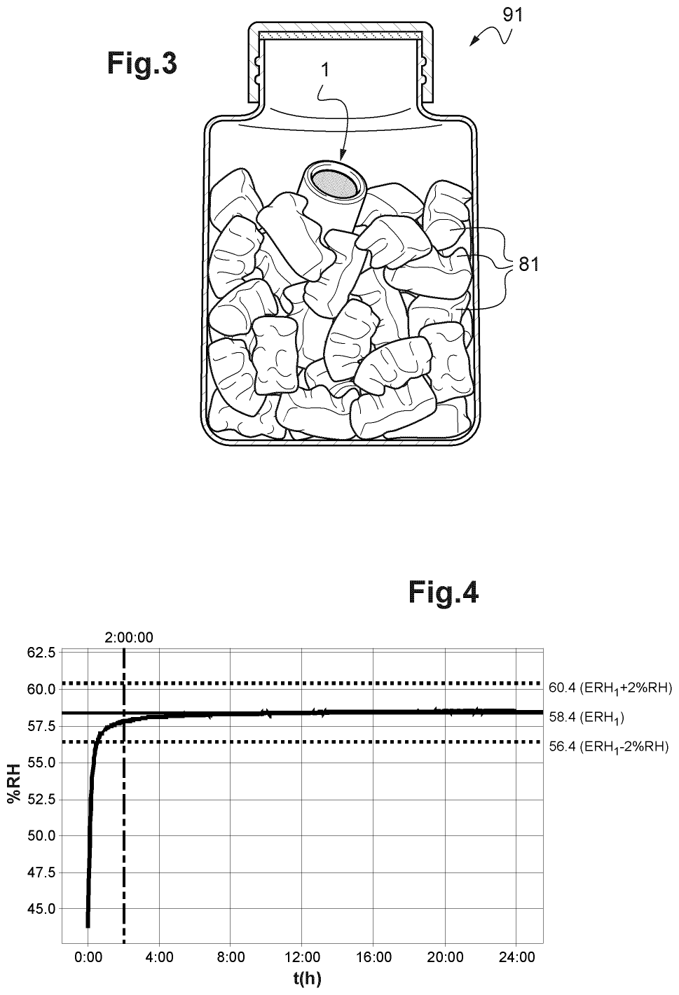

In the first embodiment shown in FIGS. 1 to 6, the humidity control device is a capsule 1 intended to be dropped in a packaging in which sensitive products are stored. By way of example, as illustrated in FIG. 3, the capsule 1 may be configured to control humidity inside a bottle 91 containing nutraceutical gummies 81 (also referred to as “gummy dosage forms”). Gummies are a useful oral administration form for patients who have difficulty swallowing pills or tablets, in particular elderly patients. Depending on the formulation, the texture and organoleptic properties of gummies may be best preserved in an environment with a relative humidity of between 45% RH and 70% RH. Typically, below 40% RH the gummies may become too hard, whereas above 70% RH they may undergo degradation of their active substance and/or become too sticky.

In this example, in order to ensure optimum storage and shelf life of the gummies 81, the humidity control capsule 1 is configured to maintain the relative humidity inside the bottle 91 within a range of +10% RH around a given equilibrium relative humidity level ERHg selected in said range of between 45% RH and 70% RH. In accordance with the invention, the humidity control agent of the capsule 1 is a hydrated superabsorbent polymer 6, making it possible to remain within said range of +10% RH thanks to its high buffering capacity.

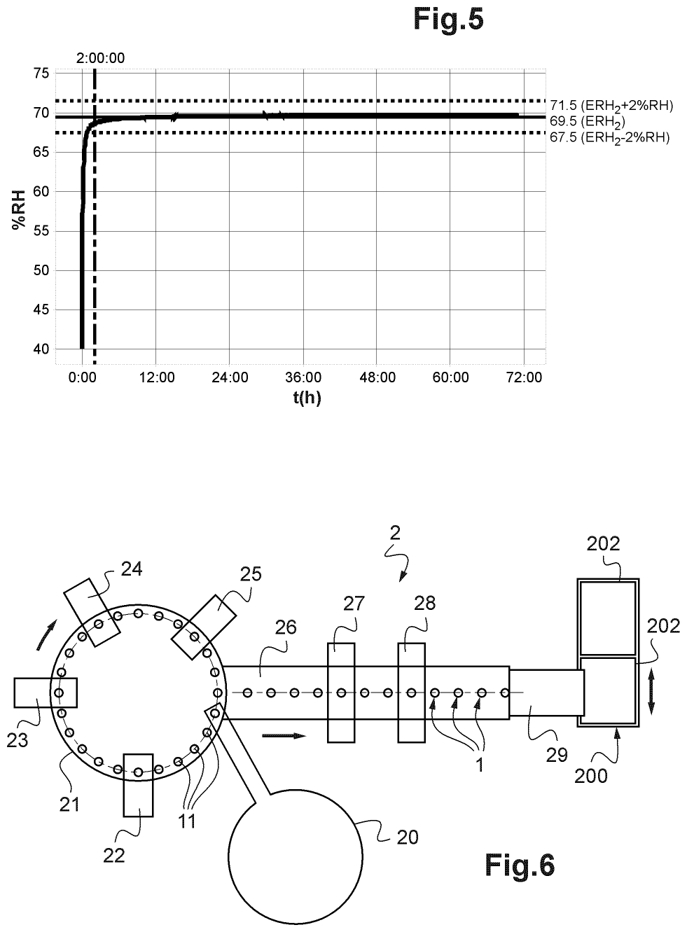

FIGS. 4 and 5 illustrate the regulation of the humidity obtained with two different types of capsules 1, comprising a first type of capsule 1 with a first targeted equilibrium relative humidity level ERH₁=58.4% RH, and a second type of capsule 1 with a second targeted equilibrium relative humidity level ERH₂=69.5% RH. The provision of humidity control capsules 1 with different targeted ERH values may be useful, for example, if a nutraceutical company has different formulations of gummies that are to be stored at different relative humidity levels.

The two types of capsules 1 of FIGS. 4 and 5 have the same structure, as shown in FIGS. 1 and 2, comprising an envelope 10 and the hydrated superabsorbent polymer 6 arranged inside the envelope 10. The envelope 10 comprises a tubular capsule body 11, with a bottom wall 12 and a side wall 13, delimiting a volume for receiving the hydrated superabsorbent polymer 6, and a gas-permeable cover 16, configured to close the capsule body 11 in such a way that the hydrated superabsorbent polymer 6 is retained inside the envelope. The two types of capsules 1 illustrated in FIG. 4 and FIG. 5 differ from each other only in the moisture content of the hydrated superabsorbent polymer 6 contained in the envelope 10, as will be detailed below.

By way of a non-limiting example, for each capsule 1 whose regulation profile is illustrated in FIG. 4 or FIG. 5, the capsule body 11 is an injection-molded part made of polypropylene; the gas-permeable cover 16 is a cardboard disc which is held in contact against a shoulder 14 of the capsule body by a thinner extension 15 of the side wall 13 which has been crimped; each capsule 1 contains 1.5 g of hydrated superabsorbent polymer 6 prepared by inserting in the capsule a given weight w_{w} of liquid water and a given weight wₚ of the product APROPACK G300 (sodium polyacrylate) sold by the company Aprotek, where the given weights w_{w} and wₚ of liquid water and APROPACK G300 are determined such that the obtained hydrated superabsorbent polymer has a moisture content corresponding to the targeted equilibrium relative humidity level ERH₁ or ERH₂.

More specifically, for the capsules 1 whose regulation profile is illustrated in FIG. 4, corresponding to the targeted equilibrium relative humidity level ERH₁=58.4% RH, the moisture content of the hydrated superabsorbent polymer 6 arranged inside the envelope 10 is 45.2%, which has been obtained by introducing in the capsule body a weight wₚ₁=0.974 g of the product APROPACK G300 having an initial moisture content of 7.75%, and a weight w_{w1}=0.365 g of liquid water. For the capsules 1 whose regulation profile is illustrated in FIG. 5, corresponding to the targeted equilibrium relative humidity level ERH₂=69.5% RH, the moisture content of the hydrated superabsorbent polymer 6 arranged inside the envelope 10 is 59.2%, which has been obtained by introducing in the capsule body a weight wₚ₂=0.981 g of the product APROPACK G300 having an initial moisture content of 7.75%, and a weight w_{w2}=0.504 g of liquid water.

Each capsule 1 thus obtained is capable of absorbing or releasing at least 100 mg of water vapor per gram of dry superabsorbent polymer, while still maintaining the relative humidity in an enclosure within a range of +10% RH around the targeted equilibrium relative humidity level ERH₁ or ERH₂. This buffering capacity, which is a property conferred by the hydrated superabsorbent polymer 6 of the capsule, ensures that the relative humidity inside the bottle 91 is maintained within a range of +10% RH around the equilibrium relative humidity level, even in the presence of instability factors, such as a certain permeability of the bottle to moisture, or the influence of the moisture content of the gummies 91 also present in the bottle.

More precisely, for the first type of capsule 1 having a hydrated superabsorbent polymer 6 with a moisture content of 45.2% corresponding to ERH₁=58.4% RH, measurements show that each capsule is capable of absorbing 140 mg of water vapor from the surrounding before ERH₁+10% RH is reached, and of releasing 135 mg of water vapor to the surrounding before ERH₁−10% RH is reached. For the second type of capsule 1 having a hydrated superabsorbent polymer 6 with a moisture content of 59.2% corresponding to ERH₂=69.5% RH, measurements show that each capsule is capable of absorbing 230 mg of water vapor from the surrounding before ERH₂+10% RH is reached, and of releasing 140 mg of water vapor to the surrounding before ERH₂−10% RH is reached.

In addition, as visible in FIGS. 4 and 5, for each of the two types of capsules 1 thus obtained, the time required to reach the targeted equilibrium relative humidity level ERH₁ or ERH₂, within +2% RH, is less than 2 hours in the measurement conditions as mentioned above, i.e. where twenty humidity control capsules 1 are placed in an empty and moisture-tightly closed glass vessel having a volume of 300 mL, which corresponds to 100 g of hydrated superabsorbent polymer per liter of air in the closed glass vessel. More precisely, measurements show that, for the first type of capsule 1 having a hydrated superabsorbent polymer 6 with a moisture content of 45.2% corresponding to ERH₁=58.4% RH, the value ERH₁−2% RH=56.4% RH is reached in less than 32 minutes, whereas for the second type of capsule 1 having a hydrated superabsorbent polymer 6 with a moisture content of 59.2% corresponding to ERH₂=69.5% RH, the value ERH₂−2% RH=67.5% RH is reached in less than 50 minutes.

FIG. 6 illustrates schematically an example of a manufacturing line 2 for manufacturing humidity control capsules 1 as described above. As shown in FIG. 6, successive operations are performed in the manufacturing line 2 to assemble and package the capsules 1, i.e. successively: each capsule body 11 is filled and closed in consecutive stations 22-25; each capsule 1 is marked in a marking station 27; each capsule 1 is controlled in a control station 28, with regard to various quality attributes such as the marking quality, the crimping quality, the presence of any visual defect; each capsule 1 is conveyed through a rotating drum 29 toward a receptacle 200, in which a removable storage package 202 is placed which is suitable for the storage of the capsules before they are used as humidity control devices.

The storage package 202 is designed to receive a plurality of capsules 1, e.g. 1000 capsules, before being removed from the receptacle 200 and sealed. In the sealed configuration, the storage package 202 is liquid and moisture tight. In one embodiment, the storage package 202 is a heat-sealable pouch made from a multilayer material comprising at least one barrier layer providing gas barrier properties, e.g. an aluminum layer, and at least one heat-sealable layer, e.g. a polyethylene layer. The material of the storage package 202 advantageously has a Water Vapor Transmission Rate (WVTR) of less than 0.1 g/m²-day (38° C., 90% RH) evaluated according to ASTM E398. Storing a plurality of humidity control capsules 1 inside the same moisture-tight storage package 202 allows moisture to equilibrate between all the capsules 1 received in the storage package, so that variations in the moisture content from one capsule 1 to another are smoothed. In this way, the tolerance interval for the moisture content and the targeted equilibrium relative humidity level ERHi of each humidity control capsule 1 is reduced compared to that obtained when each capsule 1 is packaged individually.

As shown in FIG. 6, the manufacturing line 2 comprises a carousel 21 for receiving capsule bodies 11 from a vibrating bowl 20 and for moving the capsule bodies 11 through successive stations in which they are filled and closed. Each capsule body 11 is filled first with a given weight w_{w} of liquid water, in a water filling station 22, and then with a given weight wₚ of superabsorbent polymer, in a polymer filling station 23. As explained above, the given weights w_{w} and wₚ are determined such that the obtained hydrated superabsorbent polymer has a moisture content corresponding to a targeted equilibrium relative humidity level ERHi.

By way of example, for the manufacturing of the capsules 1 whose regulation profile is illustrated in FIG. 4, respectively FIG. 5, the value w_{w1}, respectively w_{w2}, is entered as an input parameter for the water filling station 22, whereas the value wₚ₁, respectively wₚ₂, is entered as an input parameter for the polymer filling station 23. In the polymer filling station 23, the product APROPACK G300 is provided in its commercially available state, which is a substantially dry state, e.g. with a moisture content of 7.75% as described above. Each dose of said given weight wₚ of superabsorbent polymer to be introduced in a capsule body 11 may advantageously be prepared using an automatic metering device.

In the illustrated embodiment, due to the small size of the capsule bodies 11, it is advantageous to introduce the water dose in the capsule body before the superabsorbent polymer dose, to avoid any uncontrolled loss of water. In case of injection of water on a layer of superabsorbent polymer already present in a small capsule body 11, there is a risk that the water will bounce back out of the capsule body, which does not allow perfect control of the moisture content of the resulting hydrated superabsorbent polymer. However, it is understood that, in variants of the invention, for example depending on the nature of the superabsorbent polymer and/or the shape and volume of the envelope parts receiving the water and the polymer doses, the steps of water filling and polymer filling may be reversed or implemented in any sequence order, or else there may be several alternating steps of water filling and polymer filling so as to create a sandwich structure which may be advantageous for a homogeneous distribution of water in the hydrated superabsorbent polymer.

Once it has been filled with the given weights of water and superabsorbent polymer, each capsule body 11 is moved by the carousel 21 to a closing station 24 in which a cardboard disc 16 is punched and applied on top of the filled capsule body 11, resting against the shoulder 14. The capsule body 11 is then moved by the carousel 21 to a crimping station 25, in which the thinner upper extension 15 of the capsule body is crimped, so that the cardboard disc 16 is held at its periphery and closes the capsule body 11 in such a way that the hydrated superabsorbent polymer is retained therein. The carousel 21 then places the filled and closed capsules 1 on a conveyor 26 which moves each capsule 1 successively through the marking station 27 and through the control station 28 in which quality attributes of each capsule 1 are controlled by means of a camera. The conveyor 26 then routes the capsules 1 though the rotating drum 29, from which they fall into the removable storage package 202 of the receptacle 200. Advantageously, the rotating drum ensures a certain degree of mixing of the capsules 1, which may be beneficial for the homogeneity of the hydrated superabsorbent polymer 6 in the capsules.

As can be seen from the above description, the method for manufacturing humidity control capsules 1 according to the invention is very similar to existing methods for manufacturing capsules filled with granular desiccants. Interestingly, the implementation of such a manufacturing method does not require massive changes in existing manufacturing lines, especially as the additional step of hydrating the active substance is easily integrated into the existing manufacturing lines.

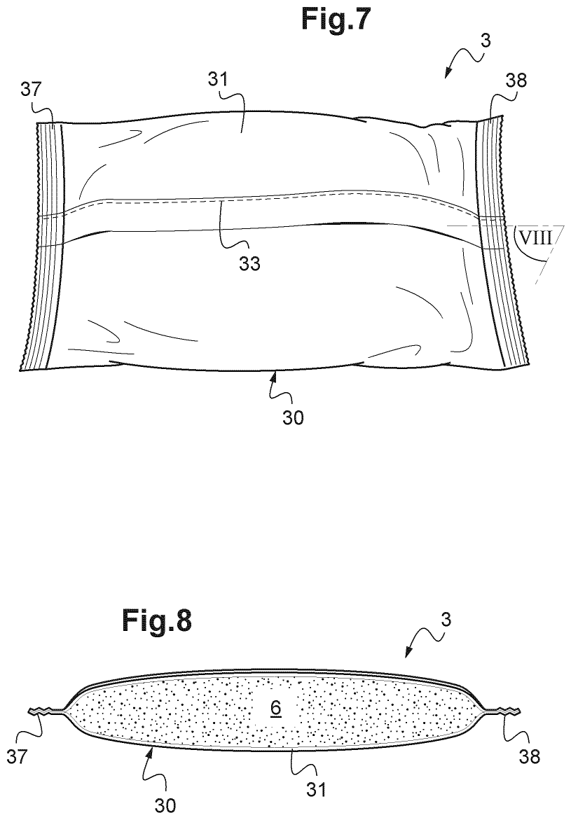

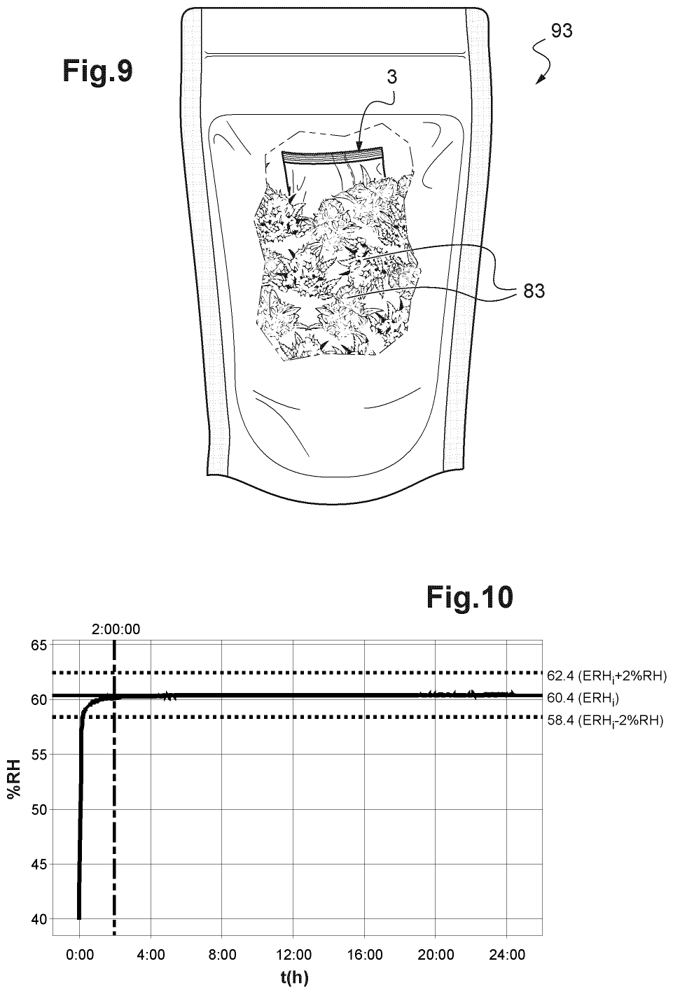

In the second embodiment shown in FIGS. 7 to 11, the humidity control device is a bag 3 intended to be dropped in a packaging in which sensitive products are stored. By way of example, as illustrated in FIG. 9, the bag 3 may be intended to control humidity inside a pouch 93 containing cannabis flowers or buds 83. The quality of cannabis flowers is best preserved in an environment with a relative humidity of between 50% RH and 65% RH. In this example, in order to ensure optimum storage and shelf life of the cannabis flowers 83, the humidity control bag 3 is configured to maintain the relative humidity inside the pouch 93 within a range of +10% RH around a given equilibrium relative humidity level ERHg of the order of 60% RH.

As shown in FIGS. 7 and 8, the bag 3 comprises an envelope 30 and a humidity control agent 6 arranged inside the envelope 30. In accordance with the invention, the humidity control agent is a hydrated superabsorbent polymer 6 retained inside the envelope 30. The envelope 30 is formed by a gas permeable membrane 31, shaped in such a way as to delimit a volume for receiving the hydrated superabsorbent polymer 6. In the example represented in FIGS. 7 and 8, the envelope 30 comprises a longitudinal seal 33 and two side seals 37, 38. The hydrated superabsorbent polymer 6 contained in the envelope 30 of the bag 3 is prepared to have an adjusted moisture content corresponding to a targeted equilibrium relative humidity level ERHi of the bag 3. The hydrated superabsorbent polymer 6 makes it possible to remain within the range of +10% RH around the targeted equilibrium relative humidity level ERHi thanks to its high buffering capacity.

FIG. 10 illustrates the regulation of the humidity obtained for a bag 3 configured to control the humidity at a targeted equilibrium relative humidity level ERHi=60.4% RH. By way of a non-limiting example, for the bag 3 whose regulation profile is illustrated in FIG. 10, the gas permeable membrane 31 of the envelope is a spun-bonded non-woven fabric BT060UW comprising polyethylene terephthalate (PET) fibers and polypropylene (PP) fibers, sold by the company Unisel Co., Ltd, which has been welded at a longitudinal seal 33 and two side seals 37, 38, as shown in FIGS. 7 and 8; the bag 3 contains 105 g of a hydrated superabsorbent polymer 6 which has been prepared in advance, before its insertion into the envelope 30, by adding a given weight w_{w} of liquid water to a given weight wₚ of the product APROPACK G300 (sodium polyacrylate) sold by the company Aprotek, having an initial moisture content of 7.75%, in such a way as to reach a moisture content of the hydrated superabsorbent polymer 6 of 46.8% corresponding to said ERHi=60.4% RH. For example, to prepare 5 kg of hydrated superabsorbent polymer 6 with a moisture content of 46.8%, a weight w_{w}=1.41 kg of liquid water is mixed with a weight wₚ=3.59 kg of the product APROPACK G300 having an initial moisture content of 7.75%.

The bag 3 thus obtained is capable of absorbing or releasing at least 100 mg of water vapor per gram of dry superabsorbent polymer, while still maintaining the relative humidity in the pouch 93 within a range of +10% RH around the equilibrium relative humidity level. In addition, as visible in FIG. 10, the time required to reach the targeted equilibrium relative humidity level ERHi=60.4% RH, within +2% RH, is less than 2 hours in the measurement conditions as mentioned above, i.e. where one bag 3 is placed in an empty and moisture-tightly closed glass vessel having a volume of 1.5 L, which corresponds to 105 g of hydrated superabsorbent polymer per liter of air in the closed glass vessel. More precisely, the value ERHi-2% RH=58.4% RH is reached in less than 14 minutes.

It is noted that the spun-bonded non-woven fabric BT060UW of the envelope 30 has a Frazier air permeability of 15±6 cm³ cm⁻²·s⁻¹, measured using the Frazier test method in accordance with standard test method ASTM D737. A test was carried out, in which an envelope with outer dimensions of 70 mm×100 mm was formed from this non-woven fabric BT060UW, having a total inner volume of about 80 cm³. This envelope was filled at a rate of 2.5 mL/s with about 50 mL (i.e. about ⅔ of total inner volume of the envelope) of liquid water without any liquid water leaking to the outer surface of the envelope.

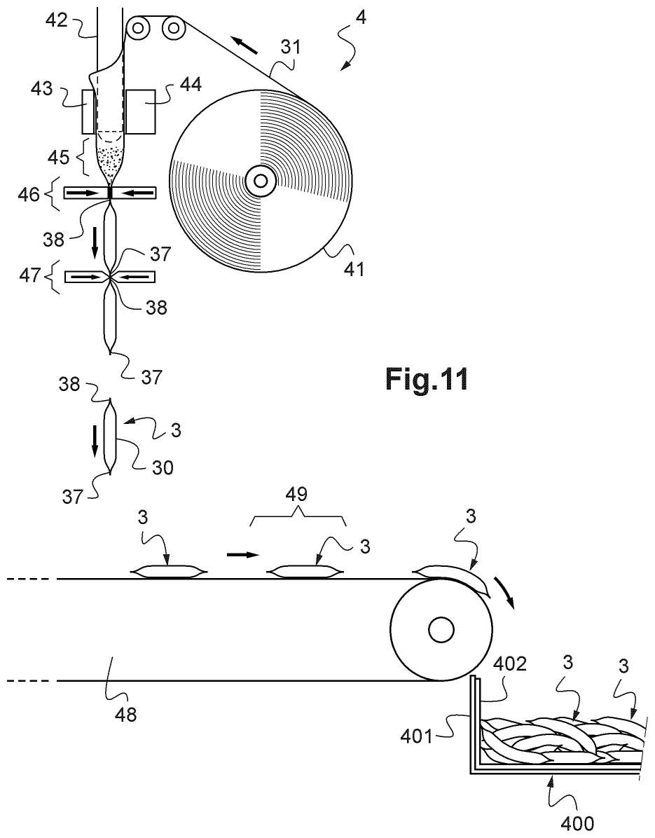

FIG. 11 illustrates schematically an example of a continuous manufacturing line 4 for manufacturing humidity control bags 3 as described above. In this second embodiment, the hydrated superabsorbent polymer 6, having the appropriate moisture content corresponding to the targeted equilibrium relative humidity level ERHi, is prepared in advance and stored in a tank (not shown) from which it is fed to a filling station 45. In this way, the desired weight of hydrated superabsorbent polymer 6 having the appropriate moisture content can be directly inserted in the envelope 30 of each bag 3 in the filling station 45, without the need to add more water in the envelope. In this example, the hydrated superabsorbent polymer 6 having said appropriate moisture content exhibits a good flowability. However, it is understood that, in other embodiments and in particular when the hydrated superabsorbent polymer with the appropriate moisture content cannot be properly handled because of its viscosity or stickiness, the superabsorbent polymer may be introduced in the envelope 30 of each bag 3 in a state where its moisture content is strictly lower than the moisture content corresponding to the targeted equilibrium relative humidity level ERHi, and water added into the envelope thereafter to reach said moisture content corresponding to the targeted equilibrium relative humidity level ERHi.

As shown in FIG. 11, successive operations are performed in the manufacturing line 4 to assemble and package the humidity control bags 3. First, the envelope 30 of the successive bags 3 is shaped, partially sealed and brought into the filling station 45 in an open configuration. For this purpose, an elongated web of non-woven material 31 is supplied from a reel 41 and wrapped around a mandrel 42 into a tubular shape comprising a longitudinal overlapping sealing area. A longitudinal seal 33 is then formed in the overlapping area, by welding the web of non-woven material 31, e.g. by ultrasonic welding, in a longitudinal welding station 43.

At the same time as the longitudinal seal 33 is formed in the longitudinal welding station 43, the envelope 30 of each bag 3 is marked in a marking station 44 positioned opposite the longitudinal welding station 43. Then, the tube of non-woven material 31 is advanced toward a transverse welding station 46, positioned downstream of the longitudinal welding station 43, in which a transverse seal is formed by welding the web of non-woven material 31 transversally to the longitudinal seal 33, e.g. by ultrasonic welding. The transverse seal formed in the transverse welding station 46 is designed to simultaneously form a first side seal 37 of an upstream bag 3 to be filled with the hydrated superabsorbent polymer 6 in the filling station 45, and a second side seal 38 of a downstream bag 3 which has already been filled with the hydrated superabsorbent polymer 6 in the filling station 45.

When the transverse seal has been formed in the transverse welding station 46, the desired weight of hydrated superabsorbent polymer 6 is inserted in the envelope 30 of the bag 3 which is received in the filling station 45. As mentioned above, the hydrated superabsorbent polymer 6 is fed to the filling station 45 directly with the appropriate moisture content corresponding to the targeted equilibrium relative humidity level ERHi. Once it has been filled with the desired weight of hydrated superabsorbent polymer 6, the bag 3 which is received in the filling station 45 is advanced until its downstream end reaches a cutting station 47, positioned downstream of the transverse welding station 46, and in this position its open upstream end is received in the transverse welding station 46.

Then, a new transverse seal is formed in the transverse welding station 46, thus forming a second side seal 38 of the bag 3 to close the upstream end of the bag 3. As explained previously, the transverse seal formed in the transverse welding station 46 also forms a first side seal 37 of an upstream bag 3 to be filled with the hydrated superabsorbent polymer 6 in the filling station 45. While the upstream end of the bag 3 is closed in the transverse welding station 46, the junction between the bag 3 and a downstream bag 3 is also cut in the cutting station 47, thus separating the first side seal 37 of the bag 3 from the second side seal 38 of the downstream bag 3. In the next step, the second side seal 38 of the bag 3 reaches the cutting station 47, where the junction between the bag 3 and an upstream bag 3 is cut. The bag 3 filled with the hydrated superabsorbent polymer 6 is thus detached from the rest of the web of non-woven material 31 and falls on a conveyor 48 configured to move the bags 3 through the last stations of the manufacturing line 4.

The bags 3 received on the conveyor travel in a control station 49, in which each bag 3 is visually inspected by an operator for various quality attributes, such as the marking quality, welding quality, and more generally the presence of any visual defect. Each bag 3 is then displaced by the conveyor 48 toward a receptacle 400, e.g. a cardboard, in which a storage package 402 is placed, e.g. a heat-sealable pouch made from a multilayer material comprising at least one barrier layer providing gas barrier properties, such as an aluminum layer, and at least one heat-sealable layer, such as a polyethylene layer. The storage package 402 is designed to receive a plurality of bags 3, e.g. 80 bags, before being sealed. In the sealed configuration, the storage package 402 is liquid and moisture tight. In a manner similar to the first embodiment, the material of the storage package 402 advantageously has a Water Vapor Transmission Rate (WVTR) of less than 0.1 g/m2-day (38° C., 90% RH) evaluated according to ASTM E398. Here again, storing a plurality of humidity control bags 3 inside the same moisture-tight storage package 402 allows moisture to equilibrate between all the bags 3 received in the storage package, so that variations in the moisture content from one bag 3 to another are smoothed. In this way, the tolerance interval for the moisture content and the targeted equilibrium relative humidity level ERHi of each humidity control bag 3 is reduced.

Here again, the method for manufacturing humidity control bags 3 according to the invention is very similar to existing methods for manufacturing bags filled with granular desiccants, and its implementation does not require massive changes in existing manufacturing lines. The only adaptations to be considered are the installation of a filling station 45 adapted to the viscosity of the hydrated superabsorbent polymer 6 having the appropriate moisture content corresponding to the targeted equilibrium relative humidity level ERHi, or alternatively, in the case where the hydrated superabsorbent polymer with the appropriate moisture content cannot be properly handled because of its viscosity or stickiness, the provision of a combination of a polymer filling station for filling the bags with the superabsorbent polymer in a substantially dry state and a water filling station.

It is noted that, in the latter case, the water filling station may come in many different forms. In one embodiment, the water filling station may be a station juxtaposed with the polymer filling station for filling the bags with the superabsorbent polymer in a substantially dry state, both stations then possibly being located at the location of the filling station 45 in FIG. 11, in which case the water and the substantially dry superabsorbent polymer are both inserted into the envelope 30 of each bag while it is still open.

In another embodiment, the water filling station may be provided downstream of the polymer filling station and the transverse welding station 46, in which case the water is inserted into the envelope 30 of each bag after the envelope has been filled with the substantially dry superabsorbent polymer and sealed.

For example, in the latter embodiment, the water filling station may comprise means for injecting liquid water into the filled and sealed envelope 30 of each bag with a syringe through a hole in the envelope and welding the hole once the desired weight of liquid water has been injected into the envelope; or the water filling station may comprise means for projecting or spraying liquid water onto the filled and sealed envelope 30 of each bag so that a desired weight of liquid water enters the envelope 30 through the porous non-woven material 31, e.g. a tunnel may be provided along the conveyor 48 to project onto the bags a given quantity of liquid water adapted to the speed of the conveyor so as to obtain the entry of a desired weight of liquid water in the envelope 30 through the porous non-woven material 31; or else the water filling station may comprise means for immersing the filled and sealed envelope 30 of each bag in a tank filled with liquid water, for a time suitable to obtain the entry of a desired weight of liquid water in the envelope 30 through the porous non-woven material 31.

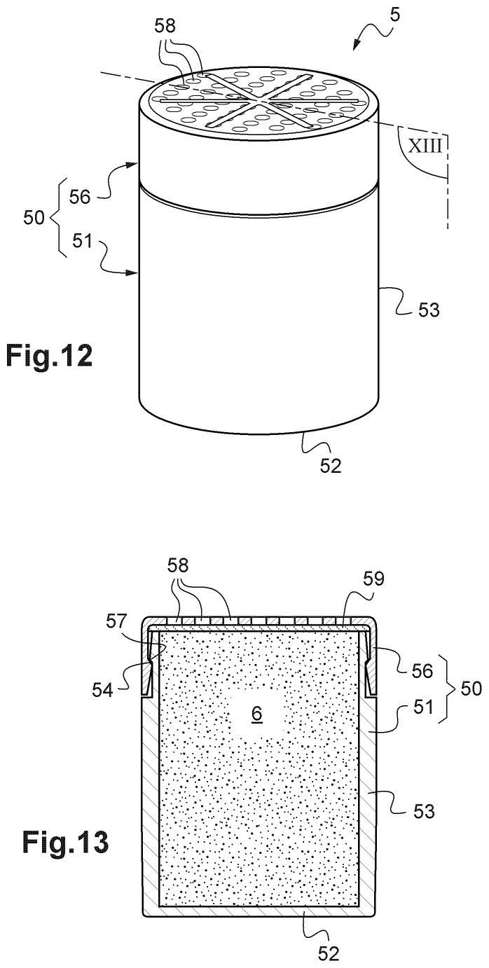

In the third embodiment shown in FIGS. 12 and 13, the humidity control device is a canister 5. In the same way as the capsule 1 of the first embodiment or the bag 3 of the second embodiment, the canister 5 is intended to be dropped in a container (not represented) in which sensitive products are stored, such as a bottle, a pouch or any other type of container. The canister 5 is configured to maintain the relative humidity inside the container within a given range around a given equilibrium relative humidity level adapted for the storage of the sensitive products. To this end, the envelope 50 of the canister 5 contains a hydrated superabsorbent polymer 6 having an adjusted moisture content corresponding to a targeted equilibrium relative humidity level.

As shown in FIGS. 12 and 13, the envelope 50 of the canister 5 comprises a tubular body 51 and a gas-permeable cap 56, which may advantageously be obtained by injection molding of a thermoplastic material such as polyethylene. The gas-permeable cap 56 is provided with a plurality of perforations 58 and is configured to be fastened on the tubular body 51, e.g. by clipping using complementary clipping members 54 and 57 of the body and the cap, as shown in FIG. 13. The tubular body 51 comprises a bottom wall 52 and a side wall 53 delimiting a volume for receiving the hydrated superabsorbent polymer 6, which is closed by the gas-permeable cap 56.

Depending on the granulometry (or particle size) of the hydrated superabsorbent polymer 6, a porous membrane may also be used to cover the perforations 58 of the cap 56, in order to avoid escape of particles of hydrated superabsorbent polymer 6 through the perforations 58 that may contaminate the products contained in the packaging. Such escape of particles may happen when the size of the particles is less than that of the perforations 58. In this case, as shown in the example of FIG. 13, a porous disc 59 may advantageously be placed against the internal face of the cap 56, e.g. a disc of non-woven fabric comprising polyethylene fibers such as TYVEK manufactured by DuPont, or a disc of gas-permeable cardboard. In particular, the porous disc 59 may be assembled with the cap 56 by inserting the disc 59 in the cap 56 or by over-molding the cap 56 around the disc 59.

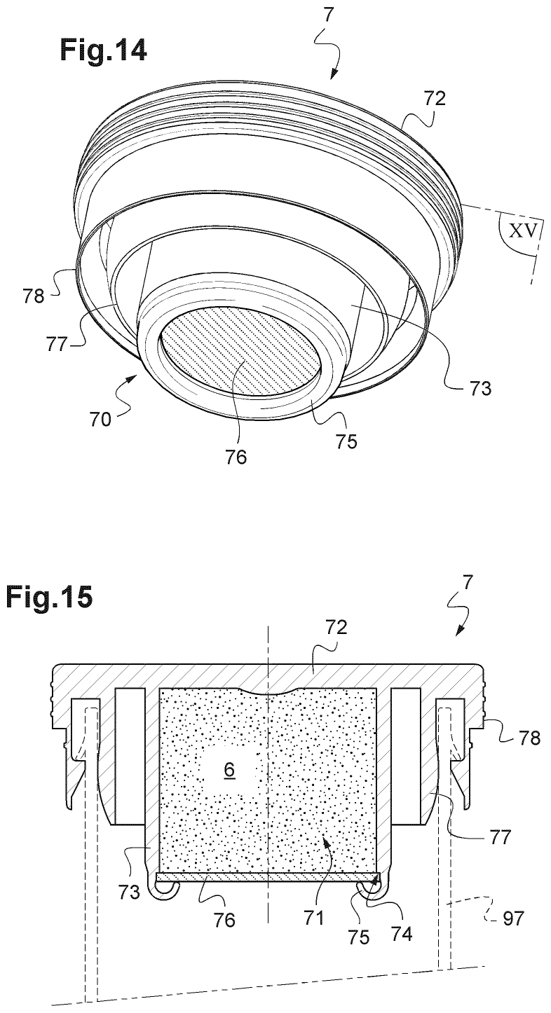

In the fourth embodiment shown in FIGS. 14 and 15, the humidity control device is a closure 7 intended to close an opening of a container 97 in which sensitive products are stored, such as a pharmaceutical or nutraceutical container. The closure 7 is configured to exchange water vapor with the inner volume of the container 97 so as to maintain the relative humidity inside the container 97 within a given range around a given equilibrium relative humidity level adapted for the storage of the sensitive products. To this end, the closure defines an envelope 70 for receiving a hydrated superabsorbent polymer 6 having an adjusted moisture content corresponding to a targeted equilibrium relative humidity level.

More precisely, the envelope 70 comprises a top wall 72 of the closure and an annular wall 73 projecting from the top wall 72, thus defining a hollow body 71 for receiving the hydrated superabsorbent polymer 6. The hollow body 71 is closed by a gas-permeable cover 76, which retains the hydrated superabsorbent polymer 6 inside the hollow body. In the represented example, the gas-permeable cover 76 is a cardboard held in contact against a shoulder 74 at its periphery by thinner extensions 75 of the annular wall 73 which have been crimped. As shown in FIG. 15, when the closure 7 is closed onto the container 97, the annular wall 73 extends towards the inside of the container 97 so that water vapor can be exchanged between the inner volume of the container 97 and the hydrated superabsorbent polymer 6.

The closure 7 also comprises a sealing skirt 77 which extends from the top wall 72 and is configured to establish a sealing contact with an inner wall surface of the container 97 surrounding its opening. Radially outside the sealing skirt 77 and concentrically arranged relative to the sealing skirt 77 is an outer rim 78. The rim 78 can for example cooperate with the sealing skirt 77 to establish a moisture-tight seal with the wall of the container 97 surrounding its opening. The rim 78 can also be connected to a tamper evident ring for providing a visual indication of first opening to an end user. The rim 78 can also comprise a surface, a cavity or any geometry facilitating the opening of the container 97 by the end user.

The invention is not limited to the examples described and shown.

In particular, for a humidity control device according to the invention, the hydrated superabsorbent polymer may be introduced in the envelope of the device directly in a hydrated state with an appropriate moisture content corresponding to the targeted equilibrium relative humidity level ERHi, as illustrated in the example of the bag of the second embodiment, it being understood that this option may also be considered for a capsule, a canister or a closure; or the hydrated superabsorbent polymer may be prepared in situ in the envelope of the device, by introducing the superabsorbent polymer in the envelope in a state where its moisture content is lower than the appropriate moisture content corresponding to the targeted ERHi, notably in a substantially dry state, and adding liquid water into the envelope to reach said appropriate moisture content corresponding to the targeted ERHi, as illustrated in the example of the capsule of the first embodiment, it being understood that this option may be also considered for a bag or packet, a canister or a closure.

Other equilibrium relative humidity levels than those illustrated above for gummies or cannabis flowers can also be targeted with a humidity control device according to the invention, comprised in the broad range of 45% RH to 90% RH. In addition, any other superabsorbent polymer can be used in a humidity control device according to the invention, as a replacement for the product APROPACK G300 disclosed in the previous examples which is a cross-linked sodium polyacrylate, for example any other cross-linked sodium polyacrylate; a cross-linked potassium polyacrylate; a cross-linked copolymer acrylamide/potassium acrylate; or a natural superabsorbent polymer.

Regarding the method of manufacturing a humidity control device according to the invention, in which a hydrated superabsorbent polymer is prepared in situ in the envelope of the humidity control device, the introduction of the superabsorbent polymer and liquid water in the envelope can be carried out in any number of steps and in any sequence order.

In the case of a bag or a packet, the water may be inserted into the envelope either before or after the envelope is sealed. In particular, as explained above, liquid water may be added to a sealed envelope filled with a humidity control agent in many possible ways, e.g., without limitation: by injecting liquid water into the filled and sealed envelope with a syringe through a hole in the envelope and welding the hole once the desired weight of liquid water has been injected into the envelope; by projecting or spraying liquid water onto the filled and sealed envelope so that a desired weight of liquid water enters the envelope through the porous non-woven material of the envelope; by immersing the filled and sealed envelope in a tank filled with liquid water, for a time suitable to obtain the entry of a desired weight of liquid water in the envelope through the porous non-woven material of the envelope.

Of course, many other variants can be considered, falling within the scope of the appended claims.

1. A humidity control device for maintaining the relative humidity in an enclosure within a given range by absorbing or releasing water vapor, said humidity control device comprising an envelope and a humidity control agent arranged inside the envelope, wherein the envelope is liquid water resistant and water vapor permeable, wherein the humidity control agent comprises a hydrated superabsorbent polymer wherein a sum of the weight of water and the weight of dry superabsorbent polymer is higher than or equal to 90% of a total weight of the humidity control agent, and wherein the hydrated superabsorbent polymer has an adjusted moisture content se selected as to provide a targeted equilibrium relative humidity level (ERHi) in a range of 45% RH to 90% RH, in a sealed container.

2. The humidity control device according to claim 1, wherein the envelope has a water vapor transfer capacity higher than 20 mg per 24 hours, in an environment at 30° C. with a relative humidity of 65% RH.

3. The humidity control device according to claim 1, wherein the liquid water resistant envelope is made entirely of a gas-permeable material having a Frazier air permeance of less than 30 cm³·cm⁻²·s⁻¹.

4. The humidity control device according to claim 1, wherein a ratio of an inner volume of the envelope to a volume of the dry superabsorbent polymer contained in the humidity control agent is less than 4.

5. The humidity control device according to claim 1, wherein the superabsorbent polymer in the composition of the humidity control agent is a superabsorbent polymer which absorbs more than 500 mg of water per gram of dry superabsorbent polymer, when the equilibrium relative humidity is increased from ERH1=50% RH to ERH2=80% RH.

6. The humidity control device according to claim 1, wherein the hydrated superabsorbent polymer, with said adjusted moisture content corresponding to the targeted equilibrium relative humidity level (ERHi) situated in the range of 50% RH to 80% RH, is capable of absorbing or releasing at least 60 mg of water vapor per gram of dry superabsorbent polymer while maintaining the relative humidity in an enclosure within a range of ±10% RH around the targeted equilibrium relative humidity level (ERHi).

7. The humidity control device according to claim 1, wherein the superabsorbent polymer is based on a cross-linked synthetic (co) polymer.

8. The humidity control device according to claim 1, wherein the superabsorbent polymer is a polymer comprising anionic charges carried by partially or totally salified acrylic acid monomers.

9. The humidity control device according to claim 1, wherein the hydrated superabsorbent polymer has an adjusted moisture content of between 10% and 150%, wherein the moisture content of the hydrated superabsorbent polymer is the ratio of the weight of water to the weight of dry superabsorbent polymer.

10. The humidity control device according to claim 1, wherein the time to reach the targeted equilibrium relative humidity level (ERHi) within ±2% RH, in an enclosure comprising said humidity control device, is less than 24 hours.

11. The humidity control device according to claim 1 in the form of a humidity control capsule or canister, wherein the liquid water resistant envelope comprises a gas-impermeable body configured to receive the hydrated superabsorbent polymer and at least one gas-permeable cover configured to close the body so that the hydrated superabsorbent polymer is retained inside the envelope.

12. The humidity control device according to claim 1 in the form of a humidity control closure intended to close an opening of a container, wherein the liquid water resistant envelope comprises walls of the closure defining a gas-impermeable body configured to receive the hydrated superabsorbent polymer and at least one gas-permeable cover configured to close the body so that the hydrated superabsorbent polymer is retained inside the envelope.

13. The humidity control device according to claim 1 in the form of a humidity control packet or bag, wherein the liquid water resistant envelope comprises a gas-permeable membrane configured to enwrap the hydrated superabsorbent polymer.

14. A closable container comprising at least one sensitive product and at least one humidity control device, wherein, in a closed state of the container containing the at least one sensitive product, the at least one humidity control device is configured to exchange water vapor with an inner volume of the container and the at least one sensitive product so as to maintain a given equilibrium relative humidity level (ERHg), wherein the at least one humidity control device comprises an envelope and a humidity control agent arranged inside the envelope, wherein the envelope is liquid water resistant and water vapor permeable, wherein the humidity control agent comprises a hydrated superabsorbent polymer such that the sum of the weight of water and the weight of dry superabsorbent polymer is higher than or equal to 90% of the total weight of the humidity control agent, and wherein the hydrated superabsorbent polymer has an adjusted moisture content selected to provide a given equilibrium relative humidity level (ERHg) in the closed container situated in the range of 45% RH to 90% RH.

15. (canceled)

16. The closable container according to claim 14, wherein the at least one sensitive product is at least one cannabis product, and wherein the hydrated superabsorbent polymer has an adjusted moisture content selected to provide a given equilibrium relative humidity level (ERHg) in the closed container situated in the range of 45% RH to 65% RH.

17. A method of manufacturing the humidity control device according to claim 1, said method comprising steps of:
a) providing the envelope;
b) introducing, in at least one part of the envelope, a given weight of the superabsorbent polymer having a known moisture content lower than or equal to the moisture content corresponding to the targeted equilibrium relative humidity level (ERHi);
c) if the known moisture content of the superabsorbent polymer is lower than the moisture content corresponding to the targeted equilibrium relative humidity level (ERHi) of the humidity control device, introducing a given weight of water in the at least one part of the envelope.

18. The method according to claim 17, wherein the superabsorbent polymer is introduced in the at least one part of the envelope in a state where its moisture content is lower than the moisture content corresponding to the targeted equilibrium relative humidity level (ERHi).

19. The method according to claim 17, wherein the given weights of water and superabsorbent polymer are introduced in the at least one part of the envelope at a rate such that the time required for the water to be absorbed by the superabsorbent polymer is lower than the time required for the water to leak out of the at least one part of the envelope.

20. The method according to claim 17, wherein the hydrated superabsorbent polymer of the humidity control device is in a powder form, a granulate form or a solid agglomerated form.

21. The method of claim 17, further comprising repeating steps b) and c) until a desired weight of hydrated superabsorbent polymer, having the moisture content corresponding to the targeted equilibrium relative humidity level (ERHi), is received in the at least one part of the envelope.

22. The humidity control device according to claim 1, wherein the liquid water resistant envelope is made of at least one part of a gas-impermeable material and at least one part of a gas-permeable material having a Frazier air permeance of less than 30 cm³·cm⁻²·s⁻¹.
